(19) United States
(12) Patent Application Publication
(10) Pub. No.: US 2026/0006190 A1
(43) Pub. Date: Jan. 1, 2026

(54) Method and Apparatus for Adaptive Loop Filter with Chroma Classifier for Video Coding

(71) Applicant: MEDIATEK INC., Hsinchu City (TW)

(72) Inventors: Yu-Ling HSIAO, Hsinchu City (TW); Shih-Chun CHIU, Hsinchu City (TW); Yu-Cheng LIN, Hsinchu City (TW); Chih-Wei HSU, Hsinchu City (TW); Ching-Yeh CHEN, Hsinchu City (TW); Tzu-Der CHUANG, Hsinchu City (TW); Yu-Wen HUANG, Hsinchu City (TW)

(21) Appl. No.: 18/992,802

(22) PCT Filed: Jun. 29, 2023
(86) PCT No.: PCT/CN2023/103570

§ 371 Date: Jan. 9, 2025

Related U.S. Application Data
(60) Provisional application No. 63/368,900, filed on Jul. 20, 2022.

(51) Int. Cl. H04N 19/117; H04N 19/176; H04N 19/186; H04N 19/82

(52) U.S. Cl. CPC H04N 19/117; H04N 19/176; H04N 19/186; H04N 19/82

(57) ABSTRACT

Method and apparatus for video coding using chroma classification for chroma ALF. According to this method, reconstructed pixels are received, where the reconstructed pixels comprise a current colour block and the current colour block comprises a luma block and one or more chroma blocks. A filtered luma output is derived from one luma ALF selected from a set of luma ALFs according to luma block classification derived for each luma ALF classification block of the luma block. A filtered chroma output is derived from one chroma ALF selected from a set of chroma ALFs according to chroma block classification derived for each chroma ALF classification block of each of said one or more chroma blocks. Filtered-reconstructed pixels are provided, where the filtered-reconstructed pixels comprise the filtered luma output and the filtered chroma output.

### CROSS REFERENCE TO RELATED APPLICATIONS

The present invention is a non-Provisional application of and claims priority to U.S. Provisional Patent Application No. 63/368,900, filed on Jul. 20, 2022. The U.S. Provisional Patent Application is hereby incorporated by reference in its entirety.

### FIELD OF THE INVENTION

The present invention relates to video coding system using ALF (Adaptive Loop Filter). In particular, the present invention relates to the ALF for the chroma component using chroma classification.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

In the present invention, Adaptive Loop Filter (ALF) with chroma classifier is disclosed for the emerging video coding development beyond the VVC.

### BRIEF SUMMARY OF THE INVENTION

A method and apparatus for video coding using ALF (Adaptive Loop Filter) are disclosed. According to the method, reconstructed pixels are received, wherein the reconstructed pixels comprise a current colour block and the current colour block comprises a luma block and one or more chroma blocks. A filtered luma output is derived from one luma ALF selected from a set of luma ALFs according to luma block classification derived for each luma ALF classification block of the luma block. A filtered chroma output is derived from one chroma ALF selected from a set of chroma ALFs according to chroma block classification derived for each chroma ALF classification block of each of said one or more chroma blocks. filtered-reconstructed pixels are provided, wherein the filtered-reconstructed pixels comprise the filtered luma output and the filtered chroma output.

In one embodiment, said one or more chroma blocks correspond to a Cb block and a Cr block, and corresponding chroma ALF classification blocks for the Cb block and the Cr block share a same chroma classification class. In one embodiment, said same chroma classification class is determined according to sample values of the corresponding chroma ALF classification blocks for the Cb block and the Cr block. In another embodiment, said same chroma classification class is determined according to sample values of the corresponding chroma ALF classification blocks for the Cb block and the Cr block and said each luma ALF classification block of the luma block.

In one embodiment, said each chroma ALF classification block corresponds to a B×B chroma block, wherein B is a positive integer. In one embodiment, the B is equal to 2. In one embodiment, the current colour block corresponds to a 4:2:0 colour block, and a 2×2 luma block in a corresponding 4×4 luma block for deriving a luma classification class is used for deriving a chroma classification class for the 2×2 chroma block. In another embodiment, the current colour block corresponds to a 4:2:0 colour block, and a luma classification class for a 2×2 luma block in a corresponding 4×4 luma block is used as a chroma classification class for the 2×2 chroma block. In another embodiment, the current colour block corresponds to a 4:4:4 colour block, and a corresponding 2×2 luma block is used to derive a chroma classification class for the 2×2 chroma block.

In one embodiment, a block value of the B×B chroma block is calculated and the block value is mapped to a look-up table, and wherein a chroma classification class is determined from the look-up table. For example, the block value of the B×B chroma block corresponds to a sample sum of the B×B chroma block. In another example, the block value of the B×B chroma block corresponds to a median sample of the B×B chroma block. In yet another example, the block value of the B×B chroma block corresponds to one sample value of the B×B chroma block.

In one example, a mapping between the block value and the look-up table is pre-defined. In another example, a mapping between the block value and the look-up table is determined adaptively. For example, analysis is applied to a picture containing the current colour block and the mapping between the block value and the look-up table is determined according to an analysis result.

In one embodiment, a mapping between the block value and the look-up table is non-uniform.

In one embodiment, a large chroma block larger than said each chroma ALF classification block is used to derive a chroma classification class for said each chroma ALF classification block.

In one embodiment, a number of chroma classification classes is less than a number of luma classification classes.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates the ALF filter shapes for the chroma (left) and luma (right) components.

FIGS. 3A-D illustrates the subsampled Laplacian calculations for gᵥ (3A), gₕ (3B), g_{d1} (3C) and g_{d2} (3D).

FIG. 4A illustrates the placement of CC-ALF with respect to other loop filters.

FIG. 4B illustrates a diamond shaped filter for the chroma samples.

FIG. 5 illustrates a flowchart of an exemplary video coding system that utilizes chroma classifier for ALF according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Adaptive Loop Filter in VVC

In VVC, an Adaptive Loop Filter (ALF) with block-based filter adaption is applied. For the luma component, one filter is selected among 25 filters for each 4×4 block, based on the direction and activity of local gradients.

### Filter Shape

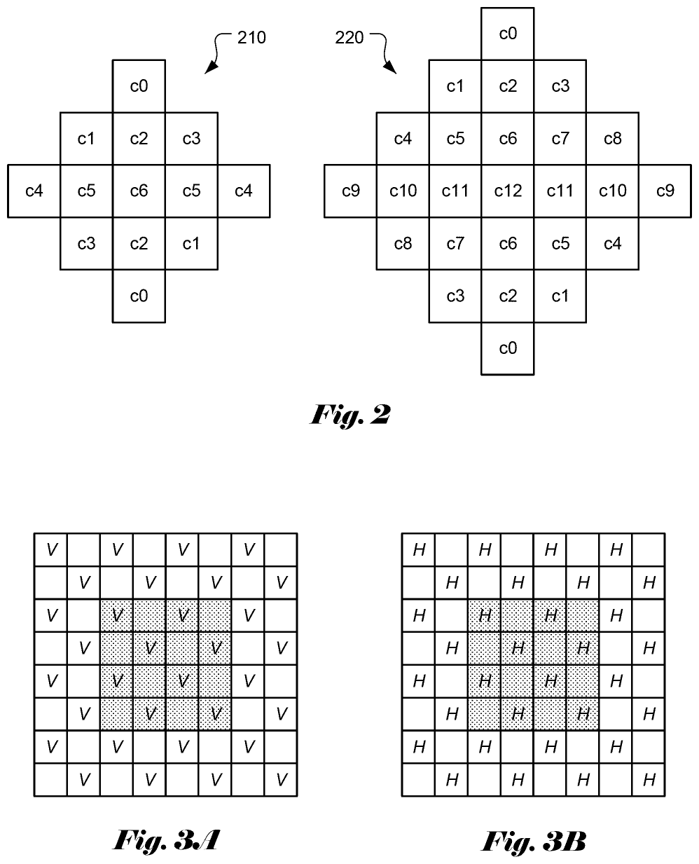

Two diamond filter shapes (as shown in FIG. 2) are used. The 7×7 diamond shape 220 is applied for luma component and the 5×5 diamond shape 210 is applied for chroma components.

### Block Classification

For luma component, each 4×4 block is categorized into one out of 25 classes. The classification index C is derived based on its directionality D and a quantized value of activity Â, as follows:

$$C = 5 D + \hat{A} .$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert ,$$

$${g}_{h} = {\sum }_{k = i - 2}^{i + 3} {\sum }_{l = j - 2}^{j + 3} {H}_{k , l} , {V}_{k , l} = \vert 2 R ( k , l ) - R ( k - 1 , l ) - R ( k + 1 , l ) \vert ,$$

$${g}_{d 1} = {\sum }_{k = i - 2}^{i + 3} {\sum }_{l = j - 3}^{j + 3} {D 1}_{k , l} , {D 1}_{k , l} = \vert 2 R ( k , l ) - R ( k - 1 , l - 1 ) - R ( k + 1 , l + 1 ) \vert ,$$

$${g}_{d 2} = {\sum }_{k = i - 2}^{i + 3} {\sum }_{j = j - 2}^{j + 3} {D 2}_{k , l} , {D 2}_{k , l} = \vert 2 R ( k , l ) - R ( k - 1 , l + 1 ) - R ( k + 1 , l - 1 ) \vert ,$$

where indices i and j refer to the coordinates of the upper left sample within the 4×4 block and R(i,j) indicates a reconstructed sample at coordinate (i,j).

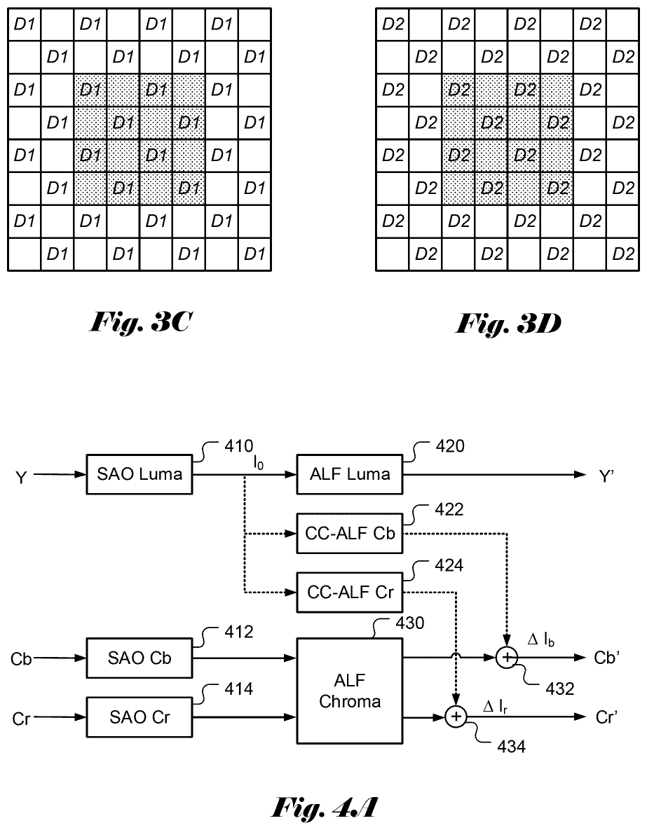

To reduce the complexity of block classification, the subsampled 1-D Laplacian calculation is applied to the vertical direction (FIG. 3A) and the horizontal direction (FIG. 3B). As shown in FIGS. 3C-D, the same subsampled positions are used for gradient calculation of all directions (g_{d1} in FIG. 3C and g_{d2} in FIG. 3D).

Then D maximum and minimum values of the gradients of horizontal and vertical directions are set as:

$$g {}_{h , v}^{max} = max ( {g}_{h ,} {g}_{v} ) , g {}_{h , v}^{min} = min ( {g}_{h ,} {g}_{v} ) .$$

The maximum and minimum values of the gradient of two diagonal directions are set as:

$$g {}_{d 0 , d 1}^{max} = max ( {g}_{d 0 ,} {g}_{d 1} ) , g {}_{d 0 , d 1}^{min} = min ( {g}_{d 0 ,} {g}_{d 1} ) .$$

To derive the value of the directionality D, these values are compared against each other and with two thresholds t₁ and t₂:

$$Step 1. If both {g}_{h , v}^{max} \leq {t}_{1} \cdot {g}_{h , v}^{min} and {g}_{d 0 , d 1}^{max} \leq {t}_{1} \cdot {g}_{d 0 , d 1}^{min} are true ,$$

$$D is set to 0.$$

$$Step 2. If {g}_{h , v}^{max} / {g}_{h , v}^{min} > {g}_{d 0 , d 1}^{max} / {g}_{d 0 , d 1}^{min} , continue from Step 3 ;$$

$$otherwise continue from Step 4.$$

$$Step 3. If {g}_{h , v}^{max} > {t}_{2} \cdot {g}_{h , v}^{min} , D is set to 2 ; otherwise D is set to 1.$$

$$Step 4. If {g}_{d 0 , d 1}^{max} > {t}_{2} \cdot {g}_{d 0 , d 1}^{min} , D is set to 4 ; otherwise D is set to 3.$$

The activity value A is calculated as:

$$A = {\sum }_{k = i - 2}^{i + 3} {\sum }_{l = j - 2}^{j + 3} ( {V}_{k , l} + {H}_{k , l} ) .$$

A is further quantized to the range of 0 to 4, inclusively, and the quantized value is denoted as Â.

For chroma components in a picture, no classification is applied.

### Geometric Transformations of Filter Coefficients and Clipping Values

Before filtering each 4×4 luma block, geometric transformations such as rotation or diagonal and vertical flipping are applied to the filter coefficients f(k, l) and to the corresponding filter clipping values c(k, l) depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$Diagonal : {f}_{D} ( k , l ) = f ( l , k ) , {c}_{D} ( k , l ) = c ( l , k ) ,$$

$$Vertical flip : {f}_{V} ( k , l ) = f ( k , K - l - 1 ) , {c}_{V} ( k , l ) = c ( k , K - l - 1 ) ,$$

$$Rotation : {f}_{R} ( k , l ) = f ( K - l - 1 , k ) , {c}_{R} ( k , l ) = c ( K - l - 1 , k ) ,$$

where K is the size of the filter and 0≤k, l≤K−1 are coefficients coordinates, such that location (0,0) is at the upper left corner and location (K−1, K−1) is at the lower right corner. The transformations are applied to the filter coefficients f(k, l) and to the clipping values c(k, l) depending on gradient values calculated for that block. The relationship between the transformation and the four gradients of the four directions are summarized in the following table.

TABLE 1
Mapping of the gradient calculated for
one block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### Filtering Process

At decoder side, when ALF is enabled for a CTB, each sample R(i,j) within the CU is filtered, resulting in sample value R′(i,j) as shown below,

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7. )$$

where f(k, l) denotes the decoded filter coefficients, K(x, y) is the clipping function and c(k, l) denotes the decoded clipping parameters. The variable k and l varies between −L/2 and L/2, where L denotes the filter length. The clipping function K(x, y)=min(y, max(−y, x)) which corresponds to the function Clip3 (−y, y, x). The clipping operation introduces non-linearity to make ALF more efficient by reducing the impact of neighbour sample values that are too different with the current sample value.

### Cross Component Adaptive Loop Filter

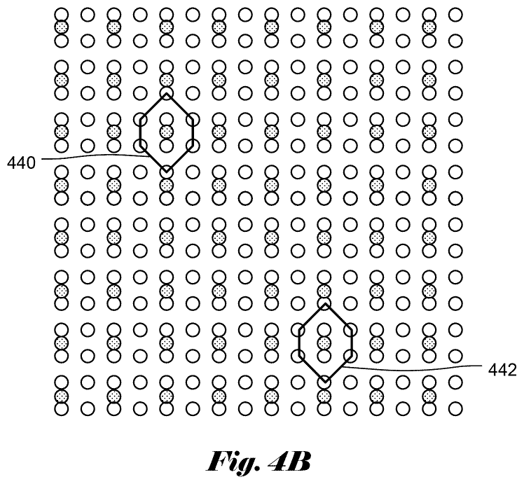

CC-ALF uses luma sample values to refine each chroma component by applying an adaptive, linear filter to the luma channel and then using the output of this filtering operation for chroma refinement. FIG. 4A provides a system level diagram of the CC-ALF process with respect to the SAO, luma ALF and chroma ALF processes. As shown in FIG. 4A, each colour component (i.e., Y, Cb and Cr) is processed by its respective SAO (i.e., SAO Luma 410, SAO Cb 412 and SAO Cr 414). After SAO, ALF Luma 420 is applied to the SAO-processed luma and ALF Chroma 430 is applied to SAO-processed Cb and Cr. However, there is a cross-component term from luma to a chroma component (i.e., CC-ALF Cb 422 and CC-ALF Cr 424). The outputs from the cross-component ALF are added (using adders 432 and 434 respectively) to the outputs from ALF Chroma 430.

Filtering in CC-ALF is accomplished by applying a linear, diamond shaped filter (e.g. filters 440 and 442 in FIG. 4B) to the luma channel. In FIG. 4B, a blank circle indicates a luma sample and a dot-filled circle indicate a chroma sample. One filter is used for each chroma channel, and the operation is expressed as:

$$Δ {I}_{i} ( x , y ) = {\sum }_{( {x}_{0} , {y}_{0} ) ∈ {S}_{i}} {I}_{0} ( {x}_{Y} + {x}_{0} , {y}_{Y} + {y}_{0} ) {c}_{i} ( {x}_{0} , {y}_{0} )$$

where (x, y) is chroma component i location being refined, (x_{Y}, y_{Y}) is the luma location based on (x, y), Sᵢ is filter support area in luma component, and cᵢ(x₀, y₀) represents the filter coefficients.

As shown in FIG. 4B, the luma filter support is the region collocated with the current chroma sample after accounting for the spatial scaling factor between the luma and chroma planes.

In the VVC reference software, CC-ALF filter coefficients are computed by minimizing the mean square error of each chroma channel with respect to the original chroma content. To achieve this, the VTM (VVC Test Model) algorithm uses a coefficient derivation process similar to the one used for chroma ALF. Specifically, a correlation matrix is derived, and the coefficients are computed using a Cholesky decomposition solver in an attempt to minimize a mean square error metric. In designing the filters, a maximum of 8 CC-ALF filters can be designed and transmitted per picture. The resulting filters are then indicated for each of the two chroma channels on a CTU basis.

Additional characteristics of CC-ALF include:
The design uses a 3×4 diamond shape with 8 taps.
Seven filter coefficients are transmitted in the APS.
Each of the transmitted coefficients has a 6-bit dynamic range and is restricted to power-of-2 values.
The eighth filter coefficient is derived at the decoder such that the sum of the filter coefficients is equal to 0.
An APS may be referenced in the slice header.
CC-ALF filter selection is controlled at CTU-level for each chroma component.
Boundary padding for the horizontal virtual boundaries uses the same memory access pattern as luma ALF.

As an additional feature, the reference encoder can be configured to enable some basic subjective tuning through the configuration file. When enabled, the VTM attenuates the application of CC-ALF in regions that are coded with high QP and are either near mid-grey or contain a large amount of luma high frequencies. Algorithmically, this is accomplished by disabling the application of CC-ALF in CTUs where any of the following conditions are true:
The slice QP value minus 1 is less than or equal to the base QP value.
The number of chroma samples for which the local contrast is greater than (1<<(bitDepth−2))−1 exceeds the CTU height, where the local contrast is the difference between the maximum and minimum luma sample values within the filter support region.
More than a quarter of chroma samples are in the range between

$$( 1 ≪ ( bitDepth - 1 ) ) - 16 and ( 1 ≪ ( bitDepth - 1 ) ) + 16$$

The motivation for this functionality is to provide some assurance that CC-ALF does not amplify artefacts introduced earlier in the decoding path (This is largely due the fact that the VTM currently does not explicitly optimize for chroma subjective quality). It is anticipated that alternative encoder implementations may either not use this functionality or incorporate alternative strategies suitable for their encoding characteristics.

### Filter Parameters Signalling

ALF filter parameters are signalled in Adaptation Parameter Set (APS). In one APS, up to 25 sets of luma filter coefficients and clipping value indexes, and up to eight sets of chroma filter coefficients and clipping value indexes could be signalled. To reduce bits overhead, filter coefficients of different classification for luma component can be merged. In slice header, the indices of the APSs used for the current slice are signalled.

Clipping value indexes, which are decoded from the APS, allow determining clipping values using a table of clipping values for both luma and Chroma components. These clipping values are dependent of the internal bitdepth. More precisely, the clipping values are obtained by the following formula:

$$AlfClip = \{ round ( {2}^{B - α * n} ) for n ∈ [ 0 .. N - 1 ] \}$$

with B equal to the internal bitdepth, α is a pre-defined constant value equal to 2.35, and N equal to 4 which is the number of allowed clipping values in VVC. The AlfClip is then rounded to the nearest value with the format of power of 2.

In slice header, up to 7 APS indices can be signalled to specify the luma filter sets that are used for the current slice. The filtering process can be further controlled at CTB level. A flag is always signalled to indicate whether ALF is applied to a luma CTB. A luma CTB can choose a filter set among 16 fixed filter sets and the filter sets from APSs. A filter set index is signalled for a luma CTB to indicate which filter set is applied. The 16 fixed filter sets are pre-defined and hard-coded in both the encoder and the decoder.

For the chroma component, an APS index is signalled in slice header to indicate the chroma filter sets being used for the current slice. At CTB level, a filter index is signalled for each chroma CTB if there is more than one chroma filter set in the APS.

The filter coefficients are quantized with norm equal to 128. In order to restrict the multiplication complexity, a bitstream conformance is applied so that the coefficient value of the non-central position shall be in the range of −2⁷ to 2⁷−1, inclusive. The central position coefficient is not signalled in the bitstream and is considered as equal to 128.

### Adaptive Loop Filter in ECM

### ALF Simplification

ALF gradient subsampling and ALF virtual boundary processing are removed. Block size for classification is reduced from 4×4 to 2×2. Filter size for both luma and chroma, for which ALF coefficients are signalled, is increased to 9×9.

ALF with Fixed Filters

To filter a luma sample, three different classifiers (C₀, C₁ and C₂) and three different sets of filters (F₀, F₁ and F₂) are used. Sets F₀ and F₁ contain fixed filters, with coefficients trained for classifiers C₀ and C₁. Coefficients of filters in F₂ are signalled. Which filter from a set F₁ is used for a given sample is decided by a class Cᵢ assigned to this sample using classifier Cᵢ.

### Filtering

At first, two 13×13 diamond shape fixed filters F₀ and F₁ are applied to derive two intermediate samples R₀(x, y) and R₁(x, y). After that, F₂ is applied to R₀(x, y), R₁(x, y), and neighbouring samples to derive a filtered sample as

$$\tilde{R} ( x , y ) + R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] ,$$

where f_{i,j} is the clipped difference between a neighbouring sample and current sample R(x, y) and gᵢ is the clipped difference between Rᵢ₋₂₀(x, y) and current sample. The filter coefficients cᵢ, i=0, . . . 21, are signalled.

### Classification

Based on directionality Dᵢ and activity Âᵢ, a class Cᵢ is assigned to each 2×2 block:

$${C}_{i} = {\hat{A}}_{i} * {M}_{D , i} + {D}_{i} ,$$

where M_{D,i} represents the total number of directionalities Dᵢ.

As in VVC, values of the horizontal, vertical, and two diagonal gradients are calculated for each sample using 1-D Laplacian. The sum of the sample gradients within a 4×4 window that covers the target 2×2 block is used for classifier C₀ and the sum of sample gradients within a 12×12 window is used for classifiers C₁ and C₂. The sums of horizontal, vertical and two diagonal gradients are denoted, respectively, as

$${g}_{h}^{i} , {g}_{v}^{i} , {g}_{d 1}^{i} and {g}_{d 2}^{i} .$$

The directionality Dᵢ is determined by comparing

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )} ,$$

with a set of thresholds. The directionality D₂ is derived as in VVC using thresholds 2 and 4.5. For D₀ and D₁, horizontal/vertical edge strength

$${E}_{HV}^{i}$$

and diagonal edge strength

$${E}_{D}^{i}$$

are calculated first. Thresholds Th=[1.25, 1.5, 2, 3, 4.5, 8] are used. Edge strength

$${E}_{HV}^{i}$$

is 0 if

$${r}_{h , v}^{i} \leq Th [ 0 ] ;$$

otherwise,

$${E}_{HV}^{i}$$

is the maximum integer such that

$${r}_{h , v}^{i} > Th [ {E}_{HV}^{i} - 1 ] .$$

Edge strength E_{D}ⁱ is 0 if

$${r}_{d 1 , d 2}^{i} \leq Th [ 0 ] ;$$

otherwise,

$${E}_{D}^{i}$$

is the maximum integer such that

$${r}_{d 1 , d 2}^{i} > Th [ {E}_{D}^{i} - 1 ] .$$

### When

$${r}_{h , v}^{i} > {r}_{d 1 , d 2}^{i} ,$$

i.e., horizontal/vertical edges are dominant, the Dᵢ is derived by using Table 2A; otherwise, diagonal edges are dominant, the Dᵢ is derived by using Table 2B.

TABLE 2A
Mapping of E_{D}ⁱ and E_{HV}ⁱ to Dᵢ

E_{D}ⁱ

| E_{HV}ⁱ | 0 | 1 | 2 | 3 | 4 | 5 | 6 |
|---|---|---|---|---|---|---|---|
| 0 | 0 | 0 | 0 | 0 | 0 | 0 | 0 |
| 1 | 1 | 2 | 0 | 0 | 0 | 0 | 0 |
| 2 | 3 | 4 | 5 | 0 | 0 | 0 | 0 |
| 3 | 6 | 7 | 8 | 9 | 0 | 0 | 0 |
| 4 | 10 | 11 | 12 | 13 | 14 | 0 | 0 |
| 5 | 15 | 16 | 17 | 18 | 19 | 20 | 0 |
| 6 | 21 | 22 | 23 | 24 | 25 | 26 | 27 |

TABLE 2B
Mapping of E_{D}ⁱ and E_{HV}ⁱ to Dᵢ

E_{HV}ⁱ

| E_{D}ⁱ | 0 | 1 | 2 | 3 | 4 | 5 | 6 |
|---|---|---|---|---|---|---|---|
| 0 | 28 | 0 | 0 | 0 | 0 | 0 | 0 |
| 1 | 29 | 30 | 0 | 0 | 0 | 0 | 0 |
| 2 | 31 | 32 | 33 | 0 | 0 | 0 | 0 |
| 3 | 34 | 35 | 36 | 37 | 0 | 0 | 0 |
| 4 | 38 | 39 | 40 | 41 | 42 | 0 | 0 |
| 5 | 43 | 44 | 45 | 46 | 47 | 48 | 0 |
| 6 | 49 | 50 | 51 | 52 | 53 | 54 | 55 |

To obtain Âᵢ, the sum of vertical and horizontal gradients Aᵢ is mapped to the range of 0 to n, where n is equal to 4 for Â₂ and 15 for Â₀ and Â₁.

In an ALF_APS, up to 4 luma filter sets are signalled, each set may have up to 25 filters.

In the present invention, techniques to improve the ALF performance are disclosed as follows.

ALF with Chroma Classifiers

In VVC and ECM ALF, classification is only applied to the luma component. In the present invention, chroma classification methods are disclosed.

### ALF Band Classifier

In ECM ALF band classifier, band classification is only applied to the luma component.

According to one embodiment of the present invention, the chroma component is also classified into different bands. In chroma classification, unlike 25 bands for the lima, we may use less bands for chroma classification, such as 10 bands. The classification rule for the chroma component can be the same as that for the luma, i.e., each 2×2 sample sum is multiplied with a number and right-shifted to determine the band class of each 2×2 block, as follows:

$$Band class C = ( 2 \times 2 sample value sum * K ) ≫ ( InputBitDepth + 2 ) ,$$

where K is a value.

In one embodiment, each 2×2 sample value sum firstly is mapped to a lookup table and then the band class of each 2×2 block is determined from the lookup table, as follows:

$$C ’ = ( 2 \times 2 sample value sum * J ) ≫ ( InputBitDepth + 2 ) , J$$

$$Band class C = LUT [ C ’ ] ,$$

where J is a value.

The band distribution in the band classifier can be pre-defined or adaptively changed. The band distribution in this disclosure refers to the relationship between the mapped band (also referred as band class) and the 2×2 sample value sum. When a lookup table is used to implement the mapping, the band distribution in the band classifier becomes an issue about the lookup table design.

In another embodiment, the entry of lookup table can be non-uniformly (or unevenly) distributed. For example, some band classes may be present in the lookup table less frequently. An example of lookup table design is as follows:

$$LUT [ 50 ] = \{ 0 , 0 , 0 , 0 , 1 , 2 , 3 , 4 , 5 , 6 , 7 , 8 , 8 , 9 , 9 , 10 , 10 , \\ 11 , 11 , 12 , 12 , 13 , 13 , 14 , 14 , 15 , 15 , 16 , 16 , 17 , 17 , 18 , 18 , \\ 19 , 19 , 20 , 20 , 21 , 21 , 21 , 22 , 22 , 22 , 23 , 23 , 23 , 24 , 24 , 24 , 24 \}$$

In another embodiment, before performing band classification, the whole picture is analyzed first and the band distribution is adaptively determined according to some rules, such as following the sample sum distribution in the picture.

In another embodiment, the number of entries in the lookup table is a number of 2 with power of N and the band class is calculated as follows:

$$C ’ = ( 2 \times 2 sample value sum ) ≫ ( InputBitDepth - M ) ,$$

$$Band class C = LUT [ C ’ ] ,$$

where M is a value.

In another embodiment, for each 2×2 block, median sample value inside each 2×2 block is calculated and used instead of the 2×2 sample sum.

In another embodiment, for each 2×2 block, instead of 2×2 sample sum, one of the four samples is used to derive the band class.

In another embodiment, for each 2×2 block, a larger window is utilized to derive the band class. For example, a 4×4 sample sum is calculated and used to derive the band class of the center 2×2 block.

In the example of chroma classifier disclosed above, the chroma classification is applied to a 2×2 chroma block. The 2×2 chroma block is selected for the purpose of illustration. The present invention is not limited to this particular chroma block size for the chroma classification. Instead, the chroma classification according to the present invention can be based on B×B chroma block, where B is a positive integer. The B×B chroma block for chroma classification is referred as a chroma ALF classification block in this disclosure. Furthermore, the sample value sum of the B×B (e.g. 2×2) chroma block is used to derive the band class. Again, the sample value sum is used as an example to derive the band class. The sample value sum should not be construed as limitations to the present invention. As is disclosed in a later part of this disclosure, other representative value of the B×B chroma block may also be used. The representative value of the B×B chroma block is referred as block value of the B×B chroma block in this disclosure.

ALF Band Classifier with Luma Samples

In one embodiment, for each 2×2 block of chroma, corresponding 2×2 block of luma is used for deriving band class for 4:4:4 color format, as follow:

$$Band class C for Cb ( also apply to Cr ) = ( ( Cb 2 \times 2 sample value sum + Y 2 \times 2 sample value sum ) * K ) ≫ ( InputBitDepth + 3 ) ,$$

where K is a value.

In the above embodiment, for each 2×2 block of chroma, the corresponding 4×4 block of luma is used for deriving band class for 4:2:0 color format, as follows:

$$Band class C for Cb ( also apply to Cr ) = ( ( Cb 2 \times 2 sample value sum + ( Y 4 \times 4 sample value sum ≫ 2 ) ) * K ) ≫ ( InputBitDepth + 3 ) ,$$

where K is a value.
ALF Band Classifier with Same Class for Cb and Cr

In one embodiment, each corresponding 2×2 sample values of Cb and Cr are set to the same class, i.e, each two 2×2 sample sum is multiplied with a number and right-shifted to determine the band class of each 2×2 block, as follows:

$$Band class C for Cb and Cr = ( ( Cb 2 \times 2 sample value sum + Cr 2 \times 2 sample value sum ) * K ) ≫ ( InputBitDepth + 3 ) ,$$

where K is a value.

In the above embodiment, each corresponding 2×2 sample values of Cb and Cr are set to the same class. The class is derived by considering the 2×2 Cb block, the 2×2 Cr block, and the corresponding 4×4 luma block for 4:2:0 color format, as follows:

$$Band class C for Cb and Cr = ( ( Cb 2 \times 2 sample value sum + Cr 2 \times 2 sample value sum + ( Y 4 \times 4 sample value sum ≫ 1 ) ) * K ) ≫ ( InputBitDepth + 4 ) ,$$

where K is a value.
ALF Chroma Classification from Luma Classification

In one embodiment, for a chroma sample, the luma class of corresponding 2×2 block is reused as chroma classification result for 4:2:0 color format.

In the above embodiment, for each 2×2 chroma block, luma classes of 2×2 blocks inside the corresponding 4×4 luma block are used for deriving the chroma classification for 4:2:0 color format. For example, the min, max, median, or average of the luma classes can be used.

In one embodiment, the above embodiments can be combined together. For example, the number of entries in lookup table is a number of 2 with power of N and the band class is calculated as follows:

$$C ’ = ( 4 \times 4 sample value sum ) ≫ ( InputBitDepth - M ) ,$$

$$Band class C = LUT [ C ’ ]$$

where M is a value.

The output of lookup table can be non-uniformly and one 4×4 window is used for classifying one 2×2 block. Moreover, for a chroma sample, the luma class of the corresponding 2×2 block can be reused as the chroma classification result for 4:2:0 color format.

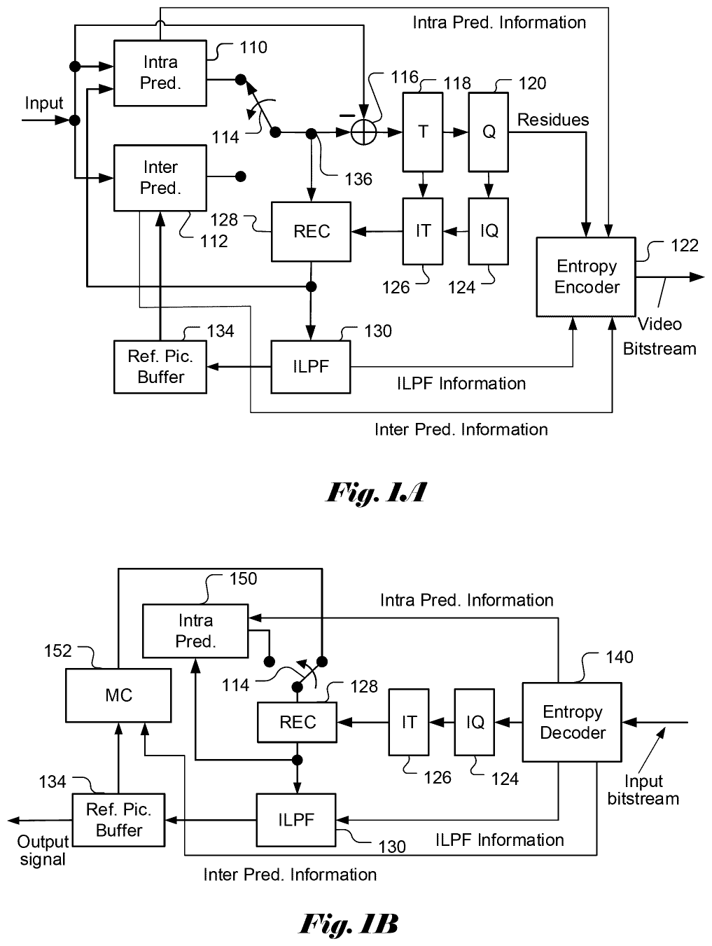

Any of the ALF methods described above can be implemented in encoders and/or decoders. For example, any of the proposed methods can be implemented in the in-loop filter module (e.g. ILPF 130 in FIG. 1A and FIG. 1B) of an encoder or a decoder. Alternatively, any of the proposed methods can be implemented as a circuit coupled to the inter coding module of an encoder and/or motion compensation module, a merge candidate derivation module of the decoder. The ALF methods may also be implemented using executable software or firmware codes stored on a media, such as hard disk or flash memory, for a CPU (Central Processing Unit) or programmable devices (e.g. DSP (Digital Signal Processor) or FPGA (Field Programmable Gate Array)).

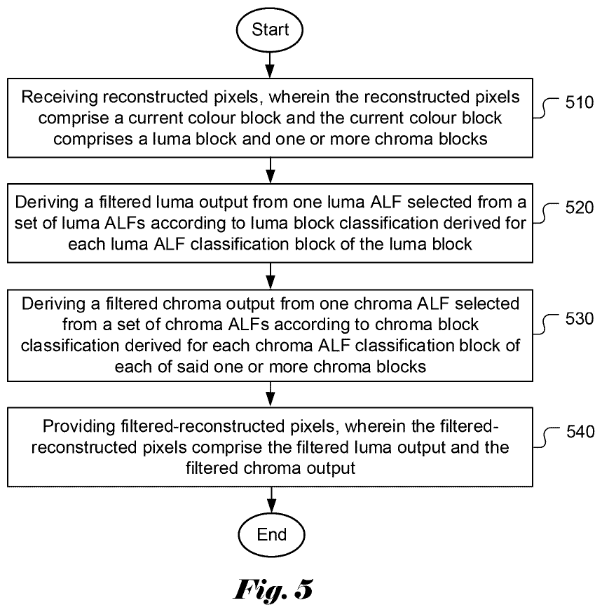

FIG. 5 illustrates a flowchart of an exemplary video coding system that utilizes chroma classification for chroma ALF according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, reconstructed pixels are received in step 510, wherein the reconstructed pixels comprise a current colour block and the current colour block comprises a luma block and one or more chroma blocks. A filtered luma output is derived from one luma ALF selected from a set of luma ALFs according to luma block classification derived for each luma ALF classification block of the luma block in step 520. A filtered chroma output is derived from one chroma ALF selected from a set of chroma ALFs according to chroma block classification derived for each chroma ALF classification block of each of said one or more chroma blocks in step 530. Filtered-reconstructed pixels are provided in step 540, wherein the filtered-reconstructed pixels comprise the filtered luma output and the filtered chroma output.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for Adaptive Loop Filter (ALF) processing of reconstructed video, the method comprising:
receiving reconstructed pixels, wherein the reconstructed pixels comprise a current colour block and the current colour block comprises a luma block and one or more chroma blocks;
deriving a filtered luma output from one luma ALF selected from a set of luma ALFs according to luma block classification derived for each luma ALF classification block of the luma block;
deriving a filtered chroma output from one chroma ALF selected from a set of chroma ALFs according to chroma block classification derived for each chroma ALF classification block of each of said one or more chroma blocks; and
providing filtered-reconstructed pixels, wherein the filtered-reconstructed pixels comprise the filtered luma output and the filtered chroma output.

2. The method of claim 1, wherein said one or more chroma blocks correspond to a Cb block and a Cr block, and corresponding chroma ALF classification blocks for the Cb block and the Cr block share a same chroma classification class.

3. The method of claim 2, wherein said same chroma classification class is determined according to sample values of the corresponding chroma ALF classification blocks for the Cb block and the Cr block.

4. The method of claim 2, wherein said same chroma classification class is determined according to sample values of the corresponding chroma ALF classification blocks for the Cb block and the Cr block and said each luma ALF classification block of the luma block.

5. The method of claim 1, wherein said each chroma ALF classification block corresponds to a B×B chroma block, wherein B is a positive integer.

6. The method of claim 5, wherein the B is equal to 2.

7. The method of claim 6, wherein the current colour block corresponds to a 4:2:0 colour block, and a 2×2 luma block in a corresponding 4×4 luma block for deriving a luma classification class is used for deriving a chroma classification class for the 2×2 chroma block.

8. The method of claim 6, wherein the current colour block corresponds to a 4:2:0 colour block, and a luma classification class for a 2×2 luma block in a corresponding 4×4 luma block is used as a chroma classification class for the 2×2 chroma block.

9. The method of claim 6, wherein the current colour block corresponds to a 4:4:4 colour block, and a corresponding 2×2 luma block is used to derive a chroma classification class for the 2×2 chroma block.

10. The method of claim 5, wherein a block value of the B×B chroma block is calculated and the block value is mapped to a look-up table, and wherein a chroma classification class is determined from the look-up table.

11. The method of claim 10, wherein the block value of the B×B chroma block corresponds to a sample sum of the B×B chroma block.

12. The method of claim 10, wherein the block value of the B×B chroma block corresponds to a median sample of the B×B chroma block.

13. (canceled)

14. The method of claim 10, wherein a mapping between the block value and the look-up table is pre-defined.

15. The method of claim 10, wherein a mapping between the block value and the look-up table is determined adaptively.

16. The method of claim 15, wherein analysis is applied to a picture containing the current colour block and the mapping between the block value and the look-up table is determined according to an analysis result.

17. The method of claim 10, wherein a mapping between the block value and the look-up table is non-uniform.

18. The method of claim 1, wherein a large chroma block larger than said each chroma ALF classification block is used to derive a chroma classification class for said each chroma ALF classification block.

19. The method of claim 1, wherein the chroma block classification uses a same classification rule as the luma block classification.

20. The method of claim 1, wherein a number of chroma classification classes is less than a number of luma classification classes.

21. An apparatus for Adaptive Loop Filter (ALF) processing of reconstructed video, the apparatus comprising one or more electronic circuits or processors arranged to:
receive reconstructed pixels, wherein the reconstructed pixels comprise a current colour block and the current colour block comprises a luma block and one or more chroma blocks;
derive a filtered luma output from one luma ALF selected from a set of luma ALFs according to luma block classification derived for each luma ALF classification block of the luma block;
derive a filtered chroma output from one chroma ALF selected from a set of chroma ALFs according to chroma block classification derived for each chroma ALF classification block of each of said one or more chroma blocks; and
provide filtered-reconstructed pixels, wherein the filtered-reconstructed pixels comprise the filtered luma output and the filtered chroma output.
